(19) United States
(12) Patent Application Publication
(10) Pub. No.: US 2013/0320062 A1
(43) Pub. Date: Dec. 5, 2013

(54) DUAL CHANNEL MAGAZINE LOCKOUT SYSTEM

(71) Applicant: ILLINOIS TOOL WORKS INC., Glenview, IL (US)

(72) Inventor: Ricardo Segura, Lake in the Hills, IL (US)

(73) Assignee: ILLINOIS TOOL WORKS INC., Glenview, IL (US)

(21) Appl. No.: 13/796,307

(22) Filed: Mar. 12, 2013

Related U.S. Application Data
(60) Provisional application No. 61/655,341, filed on Jun. 4, 2012.

(51) Int. Cl. B25C 1/00

(52) U.S. Cl. CPC B25C 1/001
USPC 227/109

(57) ABSTRACT

A magazine is provided for a fastener driver and includes a magazine housing defining a first track for slidingly accommodating a first length fastener, a second track for slidingly accommodating a second length fastener, and a follower mounted to the housing and operating between a retracted position and an advanced position, the follower having a claw constructed and arranged for engaging fasteners slidably engaged in either of said first and second tracks. The first length fastener is longer than the second length fastener, and the follower is constructed and arranged in the magazine housing such that when the second length fastener is placed in the first track, the follower claw fails to engage the second length fastener.

### RELATED APPLICATION

This application claims 35 USC 119(e) priority from U.S. Provisional application Ser. No. 61/655,341 filed Jun. 4, 2012.

### BACKGROUND

The present invention relates generally to fastener driving tools, and more specifically to magazines for such tools designed to drive fasteners of differing lengths from the same tool and using the same magazine.

Automatic fastener driving tools are well known in the art, and are operated by various power systems, including but not limited to pneumatic, combustion and electronic power sources. Regardless of the type of power system, such fastener drivers typically are equipped with magazines that store a supply of fasteners to be driven into a workpiece. The fasteners are retained together in strips and are loaded as a group into a slot in the rear of the magazine. A magazine follower includes a handle operated by the user and is provided with a return spring that biases the fasteners towards a tool nose or nosepiece which is the point at which the fastener is driven into the workpiece.

It is common for such tools to be designed to drive fasteners of varying lengths. Magazines are known having two tracks for receiving strips of fasteners, one above the other. In some known magazines, longer fastener strips are loaded into an upper track, and shorter fastener strips are loaded into the lower track.

In operation, problems have occurred when users mistakenly load shorter fasteners in the upper track. Fasteners have been known to jam inside the magazine, requiring disruption of work, if not disassembly of the tool.

In one attempt to address this problem, a plastic fastener feed adapter is slidingly secured to the rear of the magazine. The presence of the adapter reminds the user to load the fasteners in the appropriate slot. In an uppermost position, the adapter accommodates longer fasteners inserted into the slot. When shorter fasteners are employed, the adapter is slid to a lower position. However, it has been found that in use, the adapter is easily dislodged from the tool and lost, and the user has the same problem of remembering to place the shorter fasteners in the appropriate slot.

In another conventional tool, a user-activated lever is rotated to allow longer fasteners to be driven. However, if the lever is not rotated prior to loading the shorter fasteners, the tool may jam in some cases.

Accordingly, there is a need for a fastener-driving tool in which the chances for misfeeding of fasteners described above is reduced.

### SUMMARY

The above-identified need is met or exceeded by the present fastener driver magazine, featuring an upper track for slidably accommodating a first length fastener, and a lower track configured for slidably accommodating a second length fastener. A magazine follower is configured for urging the fasteners loaded in the track towards a tool nose for driving purposes. The follower is biased towards the tool nose, and includes a follower claw constructed and arranged for engaging the fasteners. In the preferred embodiment, the claw is configured for engaging a shank of the fasteners. In the preferred embodiment, the claw position in the magazine remains the same regardless of the length of the fastener loaded into the magazine. It is especially preferred that the claw is positioned in the magazine such that when a shorter fastener is improperly located in the upper track, the claw does not engage the fastener, and instead, is urged toward the nose. Once the claw engages the nose, a formation on the claw engages the nose such that the tool is prevented from completing the normal operational cycle until the follower is retracted to a rear position, permitting reloading of the fasteners.

More specifically, a magazine is provided for a fastener driver and includes a magazine housing defining a first track for slidingly accommodating a first length fastener, a second track for slidingly accommodating a second length fastener, and a follower mounted to the housing and operating between a retracted position and an advanced position, the follower having a claw constructed and arranged for engaging fasteners slidably engaged in either of said first and second tracks. The first length fastener is longer than the second length fastener, and the follower is constructed and arranged in the magazine housing such that when the second length fastener is placed in the first track, the follower claw fails to engage the second length fastener.

In the preferred embodiment the shorter fasteners are 1.5 inches long, and the longer fasteners are 2.5 inches long. Accordingly, the claw is positioned to engage the longer fasteners when loaded into the upper track, the shorter fasteners when loaded into the lower track, but not the shorter fasteners when loaded into the upper track.

### BRIEF DESCRIPTION OF THE DRAWINGS

FIG. 1 is a side elevation of a fastener driver equipped with the present magazine;

FIG. 2 is an enlarged rear elevation of the present magazine showing the fastener entry slots;

FIG. 3 is a side elevation of a strip of the longer nails;

FIG. 4 is a side elevation of a strip of the shorter nails;

FIG. 5 is a reverse side elevation of the tool shown in FIG. 1, with the magazine shown fragmentarily;

FIG. 6 is an enlarged fragmentary view of the magazine of FIG. 5;

FIG. 7 is a cross-section taken along the line 7-7 of FIG. 6 and in the direction indicated generally;

FIG. 8 is a side elevation of the tool shown in FIG. showing the relatively shorter nails loaded in the lower magazine track;

FIG. 9 is an enlarged fragmentary view of the magazine shown in FIG. 8;

FIG. 10 is vertical cross-section taken along the line 10-10 of FIG. and in the direction indicated generally;

FIG. 11 is a vertical cross section similar to FIG. 10 however showing the shorter fastener improperly loaded into the upper fastener track;

FIG. 12 is a side elevation of the tool of FIG. 1 depicting the fasteners loaded as seen in FIG. 11;

FIG. 13 is an enlarged fragmentary view of the tool of FIG. 12;

FIG. 14 is a reverse side elevation of the tool of FIG. 12 showing the follower claw missing the fasteners; and

FIG. 15 is an enlarged fragmentary view of the fastener as shown in FIG. 14.

### DETAILED DESCRIPTION

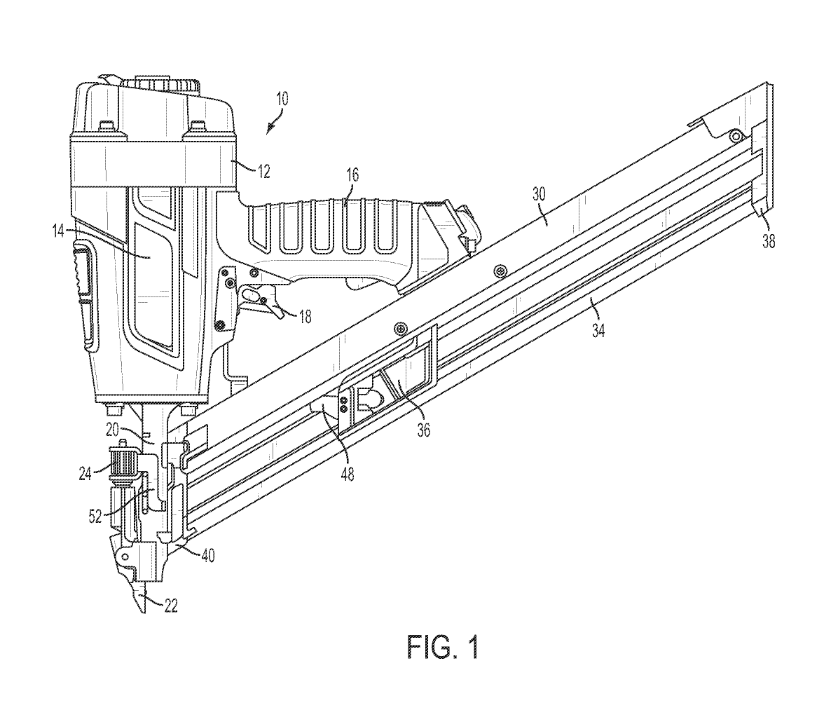

Referring to FIG. 1, a fastener-driving tool is generally designated 10, and is depicted as a pneumatically-powered driver; however the present magazine is contemplated for use with fastener-drivers powered by a variety of sources, including but not limited to pneumatic, combustion, electrical and the like. As is well known in the art, the tool 10, also referred to as a fastener driver, includes a tool housing 12 enclosing a driving assembly 14, including a reciprocating piston with an attached driver blade (not shown). A handle 16 is provided with a trigger 18, that when operated by the user, causes driving action of the piston and driver blade for driving a fastener. The driving assembly 14 is connected to a tool nose 20, through which fasteners are driven into a workpiece. As is well known, a workpiece contact element (WCE) 22 is slidably mounted on the nose 20 and is connected to the trigger 18 such that the WCE 22 must be retracted to permit proper operation of the driver for driving a faster. A depth of drive adjustment barrel 24 enables user adjustment of the relative spacing of the WCE to the nose 20.

A magazine 30 provides a supply of fasteners 32 to the nose 20. Included in the magazine is a magazine housing 34 secured to the tool nose 20 and to the handle 16. A magazine follower 36 is slidably mounted in the magazine housing and reciprocates between a retracted position near a rear end 38 of the housing and an advanced position at a front end 40 adjacent the nose 20.

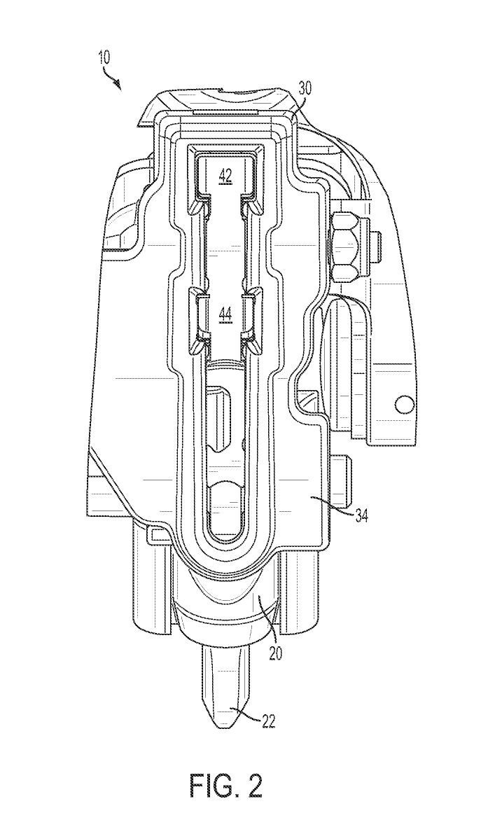

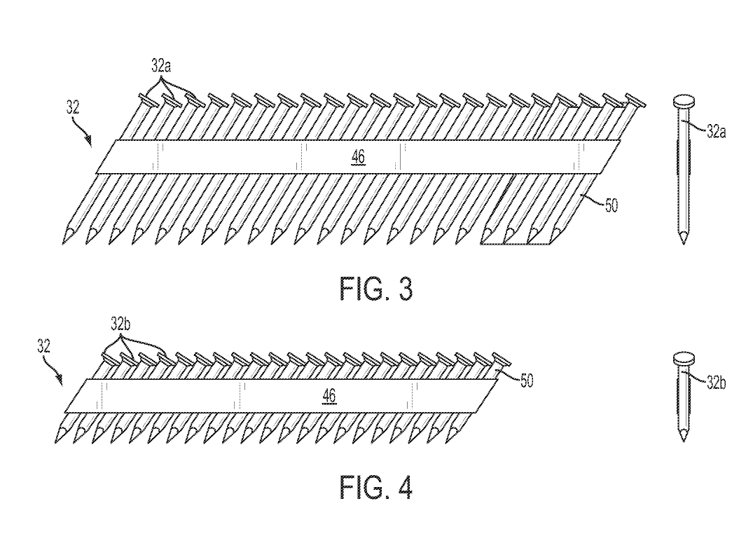

Referring now to FIGS. 1-4, the magazine includes a first fastener track 42 running a length of the magazine housing 34 and a second fastener track 44 located below the first fastener track. Both fastener tracks 42, 44 have a vertical cross section corresponding to that of the respective fasteners 32. It will be seen that the first fastener track 42 is constructed and arranged for slidingly accommodating first, longer fasteners 32a than the second fastener track 44, which is constructed and arranged for slidingly accommodating second, shorter fasteners 32b. While other fastener lengths are contemplated, in the preferred embodiment, the first fasteners 32a are 2.5 inches long, and the second fasteners 32b are 1.5 inches long. As is known in the art, the fasteners, 32a, 32b are secured together in strips held together by paper or plastic collating 46 or by adhesive.

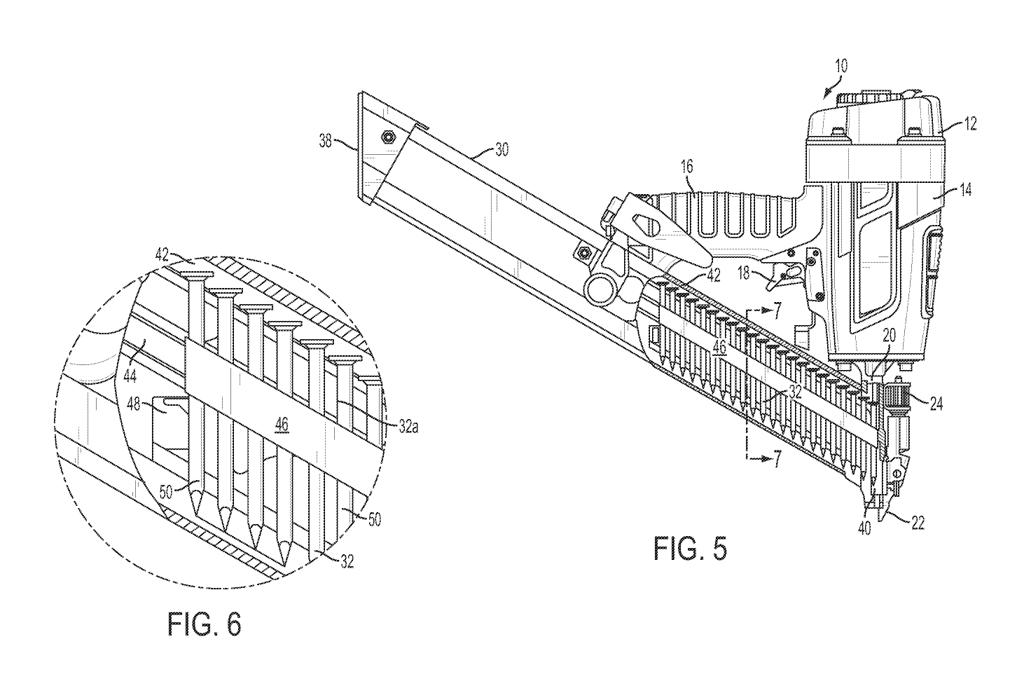

Referring now to FIGS. 1, 5 and 6, the magazine follower 36 is provided with a claw 48 which is provided in a plurality of shapes but is preferably tab-shaped or otherwise configured for engaging shanks 50 of the fasteners 32a, 32b.

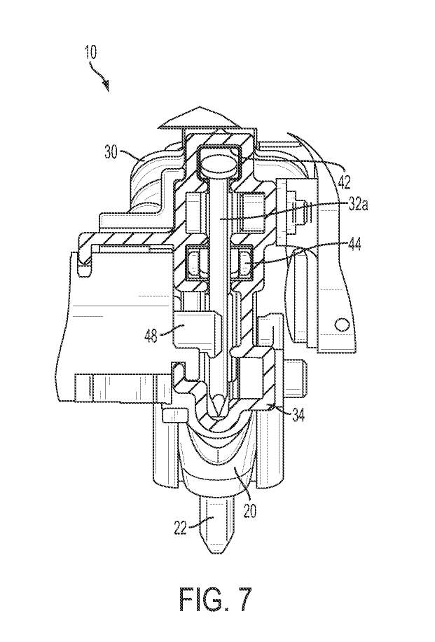

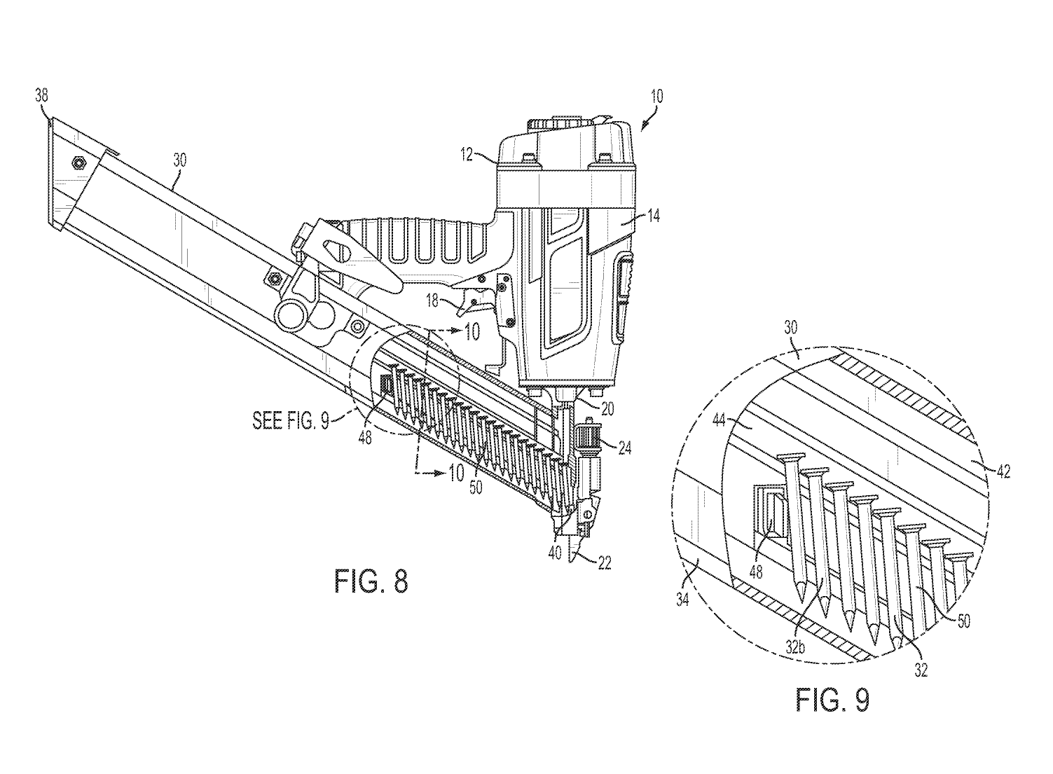

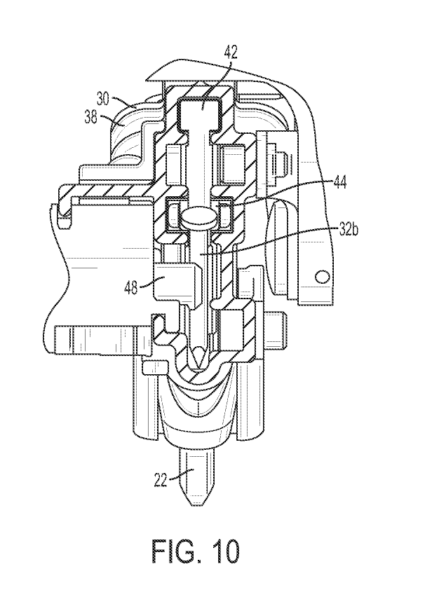

Referring now to FIG. 7, the first track 42 is seen having a first fastener properly engaged therein, and with the claw 48 engaged on the shank 50 of the fastener 32a. Similarly, referring now to FIGS. 8-10, a second fastener 32b is properly engaged in the second fastener track 44 and also being engaged by the claw 48. Note that in FIGS. 7-10, it will be seen that the claw 48 is in the same position relative to the magazine housing regardless of whether the first or the second fattener 32a, 32b is being driven by the tool 10.

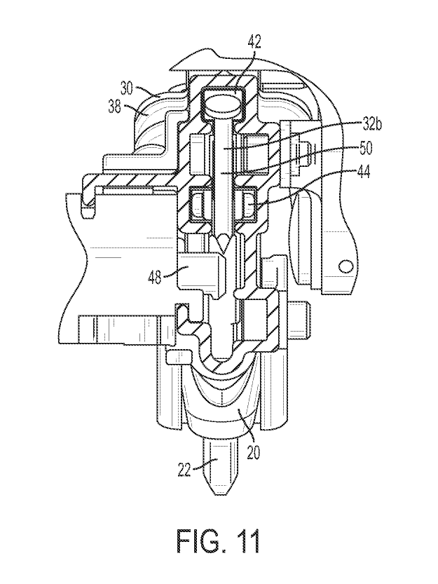

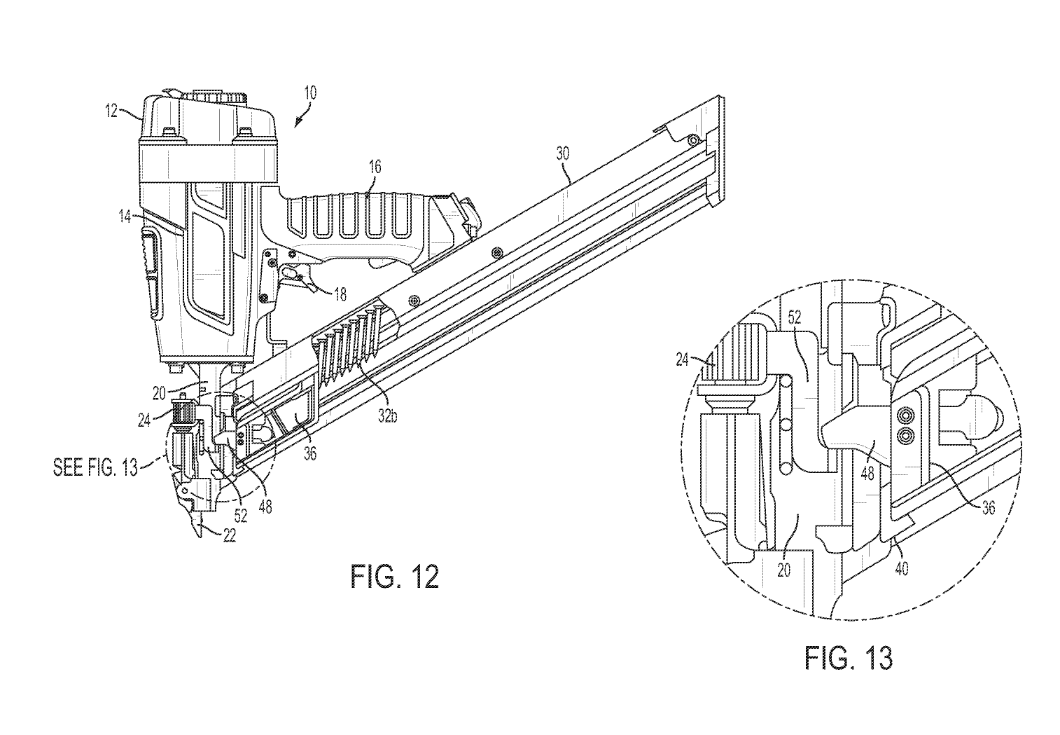

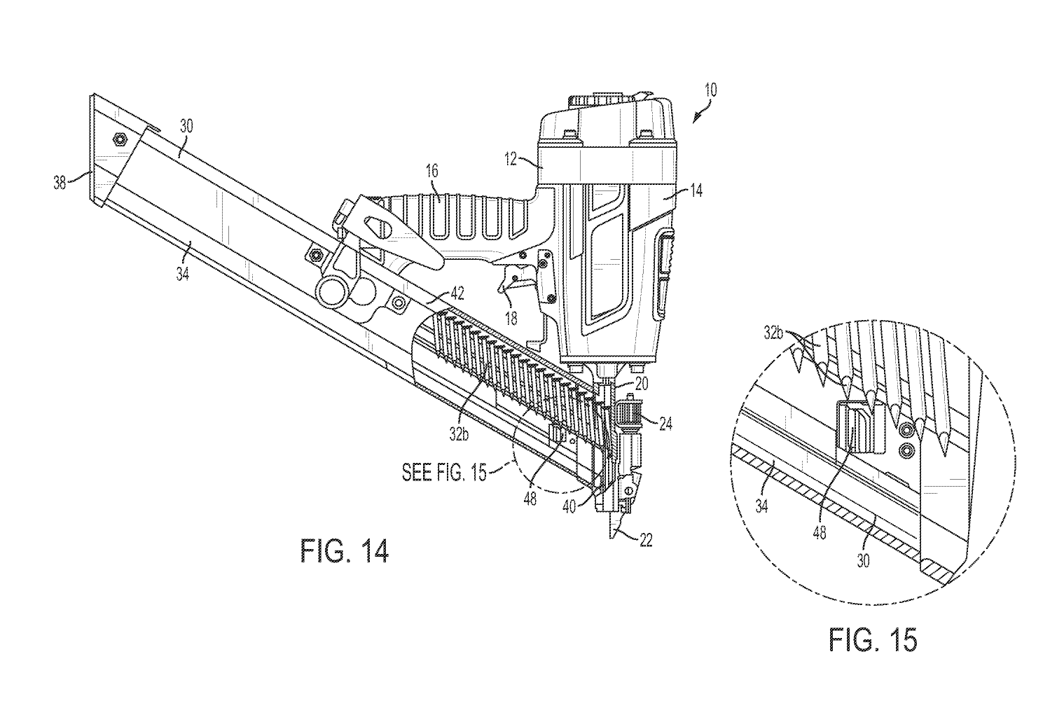

Referring now to FIGS. 11-15, in some cases, a user might mistakenly load the relatively shorter, second fasteners 32b in the first fastener track 42. As discussed above, such improper loading often results in undesirable fastener driving, as well as possible jamming of the tool such that disassembly is required, and interfering with the productivity of the user.

In the present tool 10, the magazine 30 is constructed and arranged such that when the second fastener 32b is placed in the first fastener track 42, the follower claw 48 is constructed and arranged so that the shank 50 is not engaged, but instead is entirely missed by the claw, and the claw instead is biased toward the nose 20. Once at the nose 20, the claw is inserted into the connection between the WCE and the driver 14. As such, the tool 10 will not operate until the follower 36 is withdrawn to the retracted position at the rear end 38 of the magazine.

While a particular embodiment of the present dual channel magazine lockout system has been shown and described, it will be appreciated by those skilled in the art that changes and modifications may be made thereto without departing from the invention in its broader aspects and as set forth in the following claims.

What is claimed:

1. A magazine for a fastener driver, comprising:
a magazine housing defining a first track for slidingly accommodating a first length fastener, and a second track for slidingly accommodating a second length fastener;
a follower mounted to said housing and operating between a retracted position and an advanced position;
said follower having a claw constructed and arranged for engaging fasteners slidably engaged in either of said first and second tracks;
the first length fastener being longer than the second length fastener, and said follower being constructed and arranged in said magazine housing such that when the second length fastener is placed in said first track, said follower claw fails to engage the second length fastener.

2. The magazine of claim 1 wherein said follower is biased toward said advanced position, and upon the second length fasteners being placed in said first track, said claw is forced toward a nose of the fastener-driver tool such that the tool is inoperative until the follower is moved to said retracted position.

3. The magazine of claim 1 wherein said claw has a position in said magazine housing that remains the same regardless of the length of the fastener loaded into said magazine.

4. The magazine of claim 1, wherein said first track is configured for accommodating a longer length fastener than said second track.

5. The magazine of claim 1 wherein the first length fasteners are 2.5 inches long, and said second length fasteners are 1.5 inches long.

6. The magazine of claim 1 wherein said follower is biased toward a tool nose, and said claw is positioned for engaging shanks of the fasteners properly positioned in said tracks.
